(19) United States
(12) Patent Application Publication
(10) Pub. No.: US 2006/0184870 A1
(43) Pub. Date: Aug. 17, 2006

(54) Form generation and modification system

(76) Inventors: James D. Christen, Downingtown, PA (US); Ravindar Singh Gujral, Secane, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/336,207

(22) Filed: Jan. 20, 2006

Related U.S. Application Data
(60) Provisional application No. 60/645,342, filed on Jan. 20, 2005.

(51) Int. Cl. G06F 17/24; G06F 17/21; G06F 17/30

(52) U.S. Cl. 715/506; 715/507; 715/513; 707/1

(57) ABSTRACT

A system advantageously eliminates the need for a new software release to implement modifications or a new version of an existing form, or to create a new form. The system provides data for incorporation in a form. An acquisition processor automatically acquires data representing information for incorporation in a form. A pre-processor uses predetermined rules in processing the acquired data by: parsing the acquired data to identify individual data elements in the acquired data, associating the individual data elements with corresponding locations on a target form, and storing the individual data elements and corresponding associated location data in data records. A transformation processor converts the data records into a structured language executable by a processing device.

### CROSS-REFERENCE TO RELATED APPLICATIONS

The present application is a non-provisional application of provisional application having Ser. No. 60/645,342 filed by James D. Christen, et al. on Jan. 20, 2005.

### FIELD OF THE INVENTION

The present invention generally relates to computer information systems. More particularly, the present invention relates to a form generation and modification system.

### BACKGROUND OF THE INVENTION

Computer information systems (“systems”) include computers that communicate with each other over a network, such as the Internet, and computers that manage information. For example, a healthcare enterprise uses systems to store and manage medical information, reports, documents, and forms for patients in their care.

Typically, prior systems employ software applications having different software code to generate each different paper claim form. The software code is used to manipulate and place data in the forms and to generate the output of the form.

When a change to a paper form is made or a new form is desired, time and effort is spent in changing and/or writing new software code and deploying the new software code to customers of the systems. Accordingly, there is a need for a form generation and modification system that overcomes these deficiencies and related problems of the prior systems.

### SUMMARY OF THE INVENTION

A system provides data for incorporation in a form. An acquisition processor automatically acquires data representing information for incorporation in a form. A pre-processor uses predetermined rules in processing the acquired data by: parsing the acquired data to identify individual data elements in the acquired data, associating the individual data elements with corresponding locations on a target form, and storing the individual data elements and corresponding associated location data in data records. A transformation processor converts the data records into a structured language executable by a processing device.

### BRIEF DESCRIPTION OF THE DRAWINGS

FIG. 1 illustrates a form generation and modification system, in accordance with invention principles.

FIG. 2 illustrates a method for the system, as shown in FIG. 1, in accordance with invention principles.

FIG. 3 illustrates FormLocator class definition, in accordance with invention principles.

FIG. 4 illustrates a form for use with the system 100, as shown in FIG. 1, and the method 200, as shown in FIG. 2, in accordance with invention principles.

### DETAILED DESCRIPTION OF THE PREFERRED EMBODIMENTS

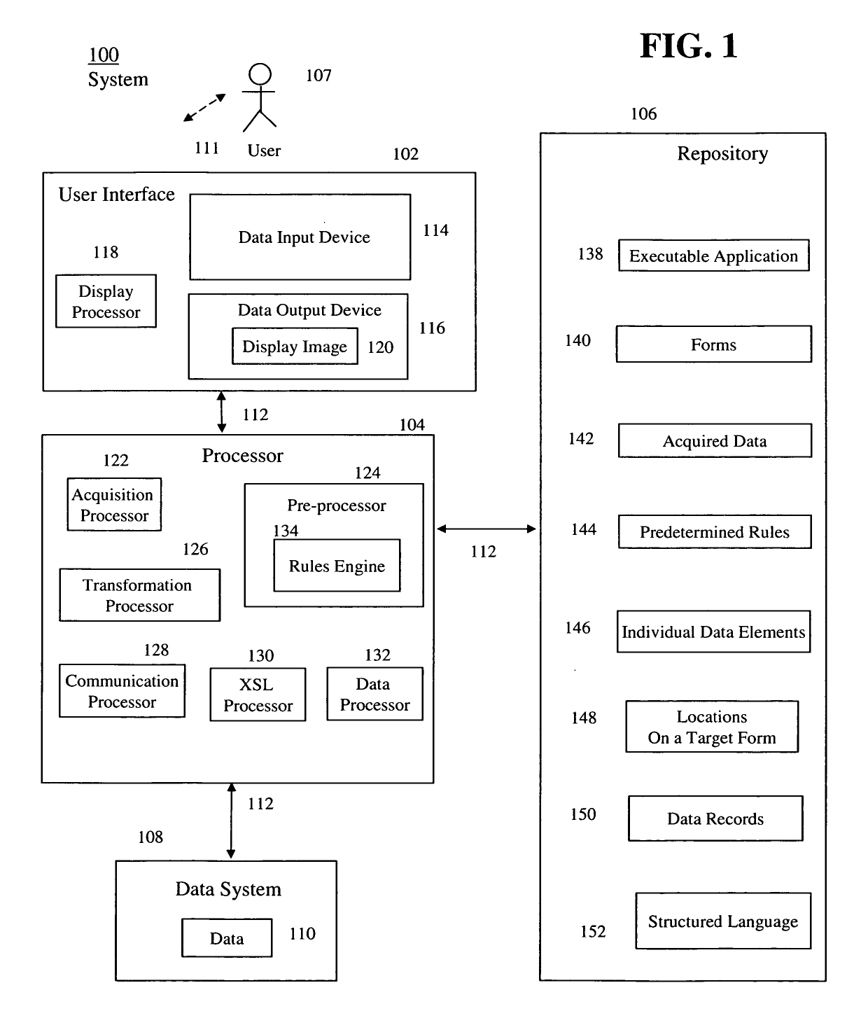

FIG. 1 illustrates a form generation and modification system (i.e., “system”) 100. The system 100 includes a user interface 102, a processor 104, and a repository 106. A user 107 and a data system 108 interact with the system 100.

A communication path 112 interconnects elements of the system 100, and/or interconnects the system 100 with the data system 108. The dotted line near reference number 111 represents interaction between the user 107 and the user interface 102.

The user interface 102 further provides a data input device 114, a data output device 116, and a display processor 118. The data output device 116 further provides one or more display images 120, which are presented for viewing by the user 107.

The processor 104 further includes an acquisition processor 122, a pre-processor 124, a transformation processor 126, a communication processor 128, an eXtensible Stylesheet Language (XSL) processor 130, and a data processor 132. The pre-processor 124 further includes a rules engine 134, which accesses predetermined rules 144 in the repository 106.

The repository 106 further includes an executable application 138, data representing one or more forms 140, acquired data 142, predetermined rules 144, individual data elements 146, data representing one or more locations on a target form 148, data records 150, and structured language 152.

The data system 108 represents a source and/or a destination of any data 110 or other information that may be needed or used by the system 100 including, for example, any of the information stored in the repository 106, such as the acquired data 142. The data 110 may be pushed to the system 100 and/or pulled by the system 100, automatically and/or manually, at one time, periodically, or as needed. The data 110 may have any format and may represent any type of information. In one example, the data 110 represents healthcare claim information in a raw claim format.

The system 100 may be employed by any type of enterprise, organization, or department, such as, for example, providers of healthcare products and/or services responsible for servicing the health and/or welfare of people in its care. For example, the system 100 represents a healthcare information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, a doctor's office, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable). The system 100 may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch.

The system 100 and/or elements contained therein also may be implemented in a centralized or decentralized configuration. The system 100 may be implemented as a client-server, web-based, or stand-alone configuration. In the case of the client-server or web-based configurations, the executable application 138 may be accessed remotely over a communication network, represented by communication path 112.

The communication path 112 (otherwise called network, bus, link, connection, channel, etc.) represents any type of protocol or data format. The protocol or data format includes, but is not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application, for example.

The data input device 114 typically provides data to a processor in response to receiving input data either manually from a user or automatically from another electronic device. For manual input, the data input device is a keyboard and a mouse, but also may be a touch screen, or a microphone and a voice recognition application, for example.

The data output device 116 typically provides data from a processor for use by a user or another electronic device. For output to a user, the data output device 116 is a display, such as, a computer monitor or screen, that generates one or more display images 120 in response to receiving the display signals from the display processor 118, but also may be a speaker or a printer, for example. The display images 120 provide information in any format including information used by a healthcare enterprise, such as any information/data stored in the repository 106. Examples of display images 120 include, for example, text, graphics, photos, images, graphs, charts, forms, etc.

The display processor 118 (e.g., a display generator) includes electronic circuitry or software or a combination of both for generating the display images 120 or portions thereof in response to receiving data representing display images, which may be stored in the repository 106. The data output device 116, implemented as a display, is coupled to the display processor 118 and displays the generated display images 120. The display images 120 provide, for example, a graphical user interface, permitting user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The acquisition processor 122 acquires data 110 representing information from the data system 108 for incorporation into a form. The acquisition processor 122 may acquire the data directly or through the communication processor 128. The processor 104 (e.g., data processor 132 in processor 104) stores the data 100, which was acquired, as acquired data 142 in the repository 106.

The pre-processor 124 processes the acquired data 142 in response to the predetermined rules 144. The pre-processor 124 parses the acquired data 142 to identify individual data elements 146 in the acquired data 142. The pre-processor 124 associates the individual data elements 146 with corresponding locations 148 on a target form. The pre-processor 124 stores the individual data elements 146 and corresponding associated location data 148 in the data records 150. The data records 150 may otherwise be called a data transformation object (DTO).

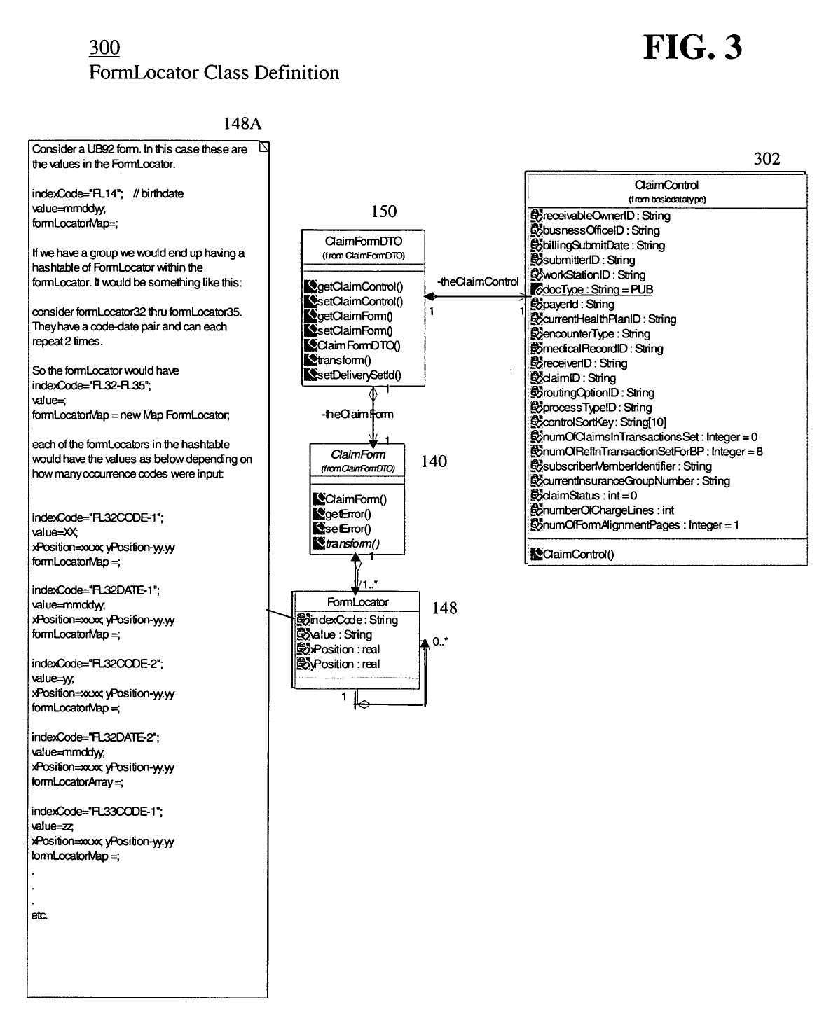

The rules engine 134 applies the predetermined rules 144 to the acquired data 142. The rules engine 134 generates data 150 having a generic output structure defined via a class incorporating a hash table, otherwise called a Generic FormLocator Object, as shown in FIG. 3, to model paper forms. A hash table is a data structure that associates keys with corresponding values using a lookup function. The hash table works by transforming the key using a hash function into a hash, which is a number that the hash table uses to locate the desired value.

A hash function, otherwise called mapping function or hash algorithm, is a function for summarizing or probabilistically identifying data. Such a summary is known as a hash value or simply a hash, and the process of computing such a value is known as hashing. The hash function is a mapping of the acquired data 142 to an integer space that defines the indices of a table where the data records 150 to be searched are stored. In other words, the hash function provides a way for assigning numbers to the acquired data 142 such that the data records 150 can then be stored in the table corresponding to the assigned number.

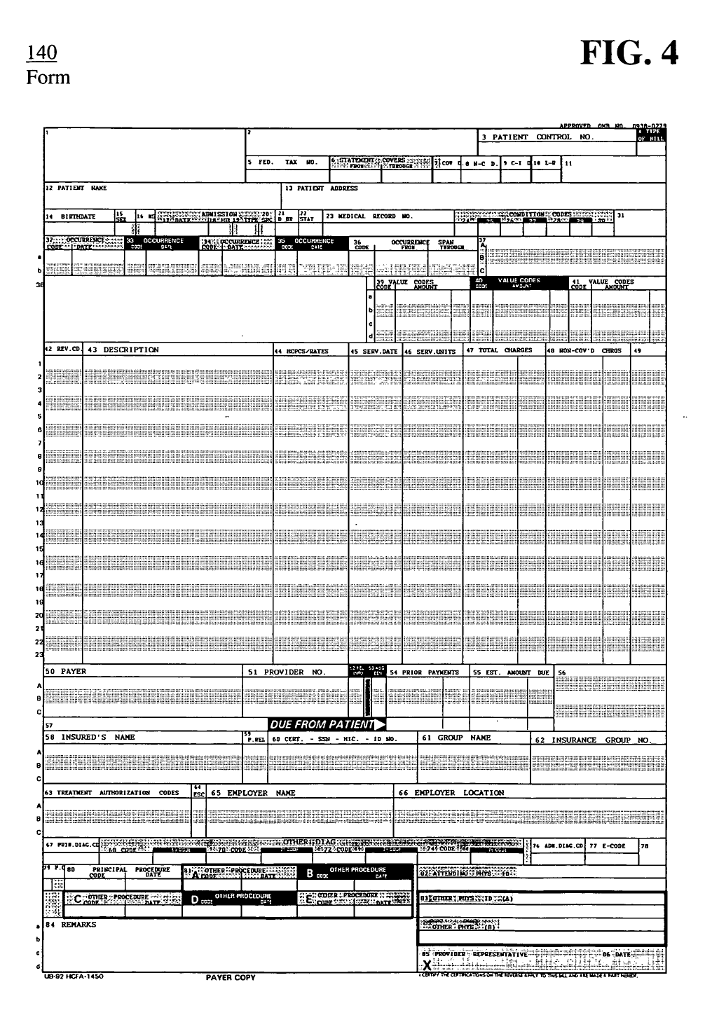

Recursive use of the hash table may also be employed, wherein an element in a first hash table can be a second hash table. FIG. 4 illustrates a form 140 having 86 numbered boxes, otherwise called form locators (FL). Form locators 42-49 provide column descriptions for charge lines 1-23. The locations of the form locators 42-49 are identified on the form 140 using Cartesian coordinates (e.g., x and y). An example of the recursive use of the hash table using form locators FL42-49 is “FL42-FL49”=null, x=null, y=null, and an object hash table consisting of ->“FL42”=001, x=5, y=19, object hash table=null; “FL43”=tonsillectomy, x=13, y=19, object hash table=null; “FL44”=etc.

The transformation processor 126 converts the data records 150 into a structured language (e.g., a structured query language (SQL)) executable by a processing device. SQL is a computer language used to create, modify and retrieve data from relational database management systems. SQL also supports object-relational database management systems.

Examples of structured language include one or more of the following: (a) Extensible Markup Language (XML), (b) Standard Generalized Markup Language (SGML), and (c) Hyper Text Markup Language (HTML). For example, the transformation processor 126 converts the data records 150 into Extensible Markup Language (XML) compatible data.

XML is a general-purpose markup language for creating special-purpose markup languages, capable of describing many different kinds of data. XML is a simplified subset of SGML. SGML is a metalanguage in which one can define markup languages for documents. XML facilitates the sharing of data across different systems, particularly systems connected via the Internet.

HTML is a markup language designed for the creation of web pages and other information viewable in a browser. HTML is used to structure information by denoting certain text as headings, paragraphs, lists, etc., and can be used to describe, to some degree, the appearance and semantics of a document.

A markup language combines text and extra information about the text. The extra information, for example about the text's structure or presentation, is expressed using markup, which is intermingled with the primary text.

The communication processor 128 manages communications within the system 100 and outside the system 100, such as, for example, with the data system 108.

The XSL processor 130 processes the structured language (e.g., XML data) to provide the individual data elements 146 in the form 140(FIG. 4). The XSL processor 130 places the individual data elements 146 in the location specified by the structured language, which corresponds to the format of the form 140. XSL is a family of languages which allows one to describe how files encoded in the XML standard are to be formatted or transformed. The individual data elements 146 may be inserted or merged into a digital form or printed on corresponding pre-printed claim forms.

The data processor 132 performs general data processing for the system 100.

The repository 106 represents any type of storage device, such as computer memory devices or other tangible storage medium, for example. The repository 106 may be implemented as a database, for example. The repository 106 represents one or more memory devices, located at one or more locations, and implemented as one or more technologies, depending on the particular implementation of the system 100.

An executable application, such as the executable application 138, comprises machine code or machine readable instruction for implementing predetermined functions including, for example, those of an operating system, a software application program, a healthcare information system, or other information processing system, for example, in response user command or input.

An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters.

The data representing one or more forms 140 (i.e., the “form”) represents any type of format that presents data. FIG. 4 shows an example of a form 140 (e.g., UB-92 used for Medicare claims). The form 140 may present data in any manner, such as, for example, that which may be interpreted by a user or by a computer.

The acquired data 142 represents the data 110 acquired by the acquisition processor 122 and stored in the repository 106.

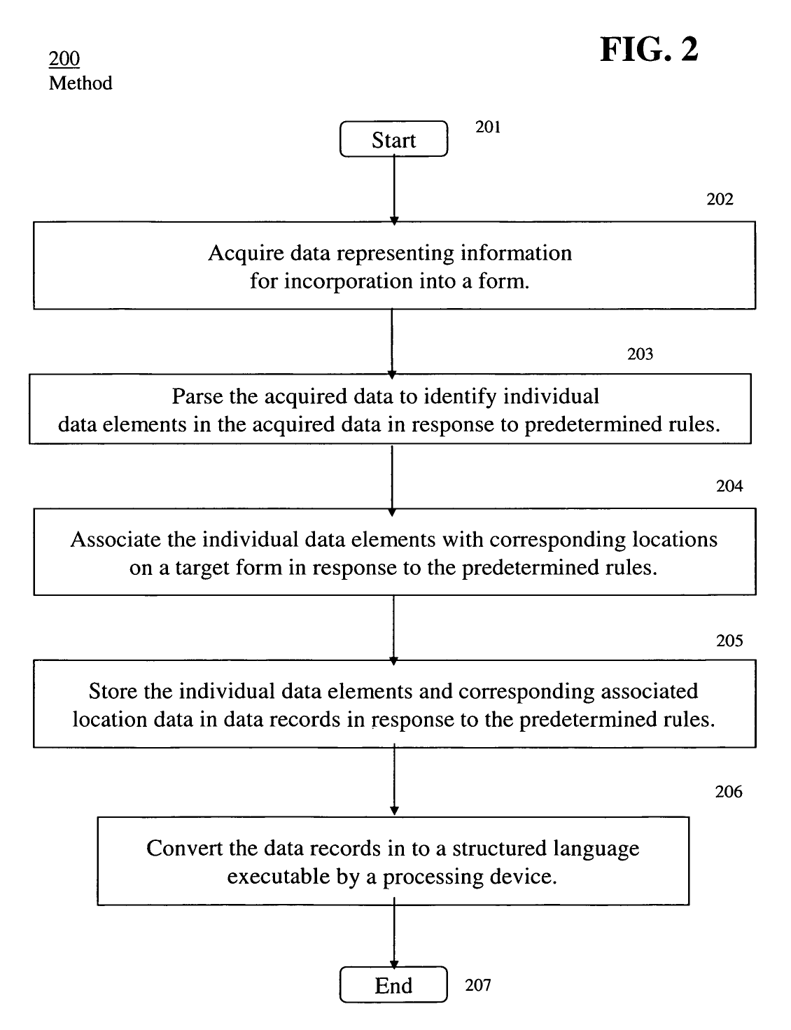

The predetermined rules 144 represent predefined decisions or choices for processing the acquired data 142, according to steps 203-204, shown in FIG. 2, for storing individual data elements 146 in the acquired data 142 and corresponding location data 148 for incorporation into a form 140. The location data 148 indicates the location where a corresponding individual data element 146 will be located on a form 140. For example, in the form 140 of FIG. 4, box 12 (i.e., form locator or FL 12) corresponds to an individual data element 146, representing “Patient Name.” In another example, in the form 140 of FIG. 4, box 43 (i.e., form locator or FL 43) corresponds to an individual data element 146 representing “Description.”

The user 107 may change the format of a form 140 by changing the rules 144. For example, the user 107 may change a particular individual data element 146 corresponding to a particular location 148 on a form 140 by modifying the rules 144. In another example, the user may change a particular location 148 corresponding to a particular individual data element 146 by modifying the rules 144. In another example, the user may add to a form 140 or delete from a form 140 an individual data element 146 and a corresponding location 148.

The rules 144 may be created or modified manually by the user 107 (e.g., via the user interface 102), automatically by the processor 104, or by a combination of the user 107 and the processor 104.

The system 100 may employ one or more sets of predetermined rules 144 to generate different data depending on various desired circumstances. For example, different sets of predetermined rules 144 may be adaptively selectable to produce corresponding different sets of data records 150 corresponding to different forms 140 or different locations on the same form 140 (i.e., different versions of the same form).

For example, different sets of predetermined rules 144 may be stored in the repository 106 and selected by the user 107 or by the processor 104. The different sets of predetermined rules 144 may be adaptively selectable by the user 107 via the user interface 102.

In another example, one or more versions of the form 140 may include an individual data element 146 in a position on the form 140 that overrides a standard element or in a different position on the form 140. The system 100 advantageously permits a user 107 to make multiple versions of a form 140 using no programmer resources other than to associate the individual data elements 146 and definition to a location on the form 140.

The individual data elements 146 comprise the acquired data 142. An individual data element may be a data object, for example.

The data representing one or more locations on a target form 148 (i.e., the “locations” or “location data”) represent locations on a form 140 that present individual data elements 146 of the acquired data 142. The location data 148 may be identified in any manner. For example, the location data 148 comprises Cartesian coordinates (i.e., X and Y coordinates), column and row identification, or box number, identifying locations for the individual data elements 146 on a form 140.

The data records 150 stores the individual data elements 146 with corresponding associated location data 148. For example, the data records 150 comprise a table, incorporating data fields including the individual data elements and associating the individual data elements with corresponding associated location coordinates. The system 100 may employ one or more sets of data records 150 in the same or different tables.

For example, first and second sets of data records 150 may include first and second individual data elements, respectively, and first and second location data, respectively. The first and second individual data elements and the first and second location data, respectively, may be nested (e.g., tiered) or not nested. When nested, the first individual data element may include a second group of individual data elements. In a particular example, the data records 150 include an individual data element 146 and corresponding associated location data 148, wherein the individual data element 146 comprises a second group of individual data elements and corresponding associated location data. The second group of individual data elements and corresponding associated location data is included in data records 150 in a table.

The structured language 152 represents a form of a machine language (e.g., XML) that may be executable (e.g., interpreted and processed) by a processing device, such as a computer or computer application.

The system 100 advantageously eliminates the need for a new software release to implement modifications or a new version of an existing form, or to create a new form. The system 100 reduces the amount of time to analyze requirements for existing or new forms. The system 100 improves programmer productivity by eliminating the need to “hard code” forms using traditional programming techniques. A user 107 who controls the rules 144 in the rules engine 134 may add or modify paper forms, without generating a new coding release, by adding to or modifying the rules 144. The system 100 beneficially permits changes to paper forms by changing the rules 144 in the rules engine 134, without requiring synchronized coordination with changes to software.

FIG. 2 illustrates a method 200 for the system 100, as shown in FIG. 1.

At step 201, the system 100 starts the method 200.

At step 202, the system 100 acquires data 110, representing information, which is stored as acquired data 142, for incorporation into a form 140.

At step 203, the system 100 parses the acquired data 142 to identify individual data elements 146 in the acquired data 142 in response to predetermined rules 144.

At step 204, the system 100 associates the individual data elements 146 with corresponding locations 148 on a target form in response to the predetermined rules 144.

At step 205, the system 100 stores the individual data elements 146 and corresponding associated location data 148 in data records 150 in response to the predetermined rules 144.

At step 206, the system 100 converts the data records 150 in to a structured language 152 (e.g., XML, SGML, or HTML), which is executable by a processing device.

At step 207, the system 100 ends the method 200.

FIG. 3 illustrates Form Locator Class Definition 300, which includes the claim routing data 302 (e.g., “ClaimControl”), the data records 150 (e.g., “ClaimFormDTO”), the claim form 140 (e.g., “ClaimForm”), and the locations 148 (e.g., “FormLocator”). The system 100 and the method 200 operate responsive to the Form Locator Class Definition 300.

The FormLocator 148 includes an indexCode identifier, a value identifier, and xPosition and yPosition identifiers. The indexCode identifier identifies the location (e.g., the box number) and the description of the location on the form 140. The value identifier identifies the format (e.g., mmddyy for month, day, and year) of the information to be inserted at the location. The xPosition and yPosition identifiers identify X and Y coordinates, respectively, for the location of the information in box number on the form 140. Examples of these identifiers in the FormLocator 148 are shown in area 148A in FIG. 3. In one particular example, while referring to the form 140 in FIG. 4:

IndexCode=”FL32CODE-1 (i.e., box 32, 1^{st} position, having a description “CODE.”

Value=XX (i.e., a two character (numbers and/or letters) code)

XPosition=xx.xx (i.e., an X coordinate between 00.00 and 99.99 on a form)

YPosition=yy.yy (i.e., an Y coordinate between 00.00 and 99.99 on a form)

The data records 150 (e.g., “ClaimFormDTO”) includes the following functions, for example, getClaimControl, setClaimControl, getClaimForm, setClaimForm, transform (i.e., the transformation processor 126), and setDeliverySetID.

The claim form 140 (e.g., “ClaimForm”) includes the following functions, for example, ClaimForm (i.e., the form), getError, setError, transform (i.e., the XSL processor 130).

The claim routing data (e.g., ClaimControl) includes information for controlling the routing of the claim (e.g., claimID, medicalRecordID, etc.).

The rules engine 134 receives data 110 from the acquisition processor 122 and incorporates a class design (e.g., Form Locator Class Definition shown in FIG. 3) in the writing of rules 144 to model any type of form locator on any type of form 140. The output of the rules engine 134 is a DTO that is translated to a structured language (e.g., XML) using the transformation processor 126. The structured language specifies the data in terms of Cartesian (e.g., X and Y positional) coordinates, for example. The XSL processor 130 converts the structured language to a printable Word document that can be printed on a pre-printed claim form, for example.

A UB92 claim form, as shown in FIG. 4, is structured as a hash table having grouped instances (“name”=value pairs) of the class FormLocator. Tables in the UB92 form, such as the charge line table (e.g., FormLocator or boxes 42-49), are a particular instance of FormLocator in that they contain a reference to another instance of FormLocator to describe the individual elements within the table. The following text describes, for example, the rules 144 used to value the fields of the charge line table.

Input Claim DTO (Charge 1 of 3)

The following illustrates an example of rules engine 134 software that values the charge lines (i.e., boxes 42-49) in the output UB92 Form hash table. The italic statements highlight the “name”=value pairs of the hash table.

```
if true
then {
    outputForm[“FL42-FL49”] = apply Group_Box_ruleset(“FL42-FL49”,999,claim1);
}
sequential ruleset Group_Box_ruleset for {boxName: a string, numberOfRows: an integer,
claim: a Claim} returning a FormLocator is
{
    FL is a FormLocator.
    i is an integer initially 0.
    j is an integer initially 0.
    FL_number is an integer.
    rowNumber is an integer initially 1.
rule Charge_Lines is
if (claim.charges <> null) and boxName=“FL42-FL49” //charge lines
then{
  FL_number = boxName.substring(2,4) as an integer;
  FL_array is an association from string to FormLocator;
  rowNumber = 1;
  i = 0;
  for each Charge in claim.charges
  do {
  // “REV CD”; (i.e., shown in box 42 of the form 140 in FIG. 4)
  FL_array[“FL”“”FL_number““”-“””rowNumber as a string] = a FormLocator;
  FL_array[“FL”“”FL_number““”-“””rowNumber as a string].value =
claim.charges[i].revenueCode;
  FL_array[“FL”“”FL_number““”-“””rowNumber as a string].XPosition = 4;
  FL_array[“FL”“”FL_number““”-“””rowNumber as a string].YPosition = 18 + rowNumber;
  print (“FL”“”FL_number““”-“””rowNumber as a string “ = ” FL_array[“FL”“”FL_number““”-
“””rowNumber as a string].value);
  FL_number = FL_number+1;
  // “DESCRIPTION”; (i.e., shown in box 43 of the form 140 in FIG. 4)
  FL_array[“FL”“”FL_number““”-“””rowNumber as a string] = a FormLocator;
  FL_array[“FL”“”FL_number““”-“””rowNumber as a string].value =
claim.charges[i].revenueCodeDescription;
  print (“FL”“”FL_number““”-“””rowNumber as a string “ = ”
FL_array[“FL”“”FL_number““”-“””rowNumber as a string].value);
  FL_array[“FL”“”FL_number““”-“””rowNumber as a string].XPosition = 9;
  FL_array[“FL”“”FL_number““”-“””rowNumber as a string].YPosition = 18 + rowNumber;
  FL_number = FL_number+1;
  // “HCPCS / RATES”; (i.e., shown in box 44 of the form 140 in FIG. 4)
  FL_array[“FL”“”FL_number““”-“””rowNumber as a string] = a FormLocator;
  FL_array[“FL”“”FL_number““”-“””rowNumber as a string].value =
claim.charges[i].procedureCode;
  print (“FL”“”FL_number““”-“””rowNumber as a string “ = ”
FL_array[“FL”“”FL_number““”-“””rowNumber as a string].value);
  FL_array[“FL”“”FL_number““”-“””rowNumber as a string].XPosition = 34;
  FL_array[“FL”“”FL_number““”-“””rowNumber as a string].YPosition = 18 + rowNumber;
  FL_number = FL_number+1;
  // “SERVICE DATE”; (i.e., shown in box 452 of the form 140 in FIG. 4)
  FL_array[“FL”“”FL_number““”-“””rowNumber as a string] = a FormLocator;
  if (claim.charges[i].fromDate <> null)
  then{
  cDate is a date initially claim.charges[i].fromDate;
  FL_array[“FL”“”FL_number““”-“””rowNumber as a string].value =
cDate.format(“MMddyyyy”);
  }
  else FL_array[“FL”“”FL_number““”-“””rowNumber as a string].value = null;
  print (“FL”“”FL_number““”-“””rowNumber as a string “ = ” FL_array[“FL”“”FL_number““”-
“””rowNumber as a string].value);
  FL_array[“FL”“”FL_number““”-“””rowNumber as a string].XPosition = 44;
  FL_array[“FL”“”FL_number““”-“””rowNumber as a string].YPosition = 18 + rowNumber;
  FL_number = FL_number+1;
  // “SERVICE UNITS”; (i.e., shown in box 46 of the form 140 in FIG. 4)
  FL_array[“FL”“”FL_number““”-“””rowNumber as a string] = a FormLocator;
  FL_array[“FL”“”FL_number““”-“””rowNumber as a string].value =
claim.charges[i].quantity as a string;
  print (“FL”“”FL_number““”-“””rowNumber as a string “ = ”
FL_array[“FL”“”FL_number““”-“””rowNumber as a string].value);
  FL_array[“FL”“”FL_number““”-“””rowNumber as a string].XPosition = 51;
  FL_array[“FL”“”FL_number““”-“””rowNumber as a string].YPosition = 18 + rowNumber;
  FL_number = FL_number+1;
  // “TOTAL CHARGES”; (i.e., shown in box 47 of the form 140 in FIG. 4)
  FL_array[“FL”“”FL_number““”-“””rowNumber as a string] = a FormLocator;
  FL_array[“FL”“”FL_number““”-“””rowNumber as a string].value =
claim.charges[i].totalChargeAmount as a string;
  print (“FL”“”FL_number““”-“””rowNumber as a string “ = ”
FL_array[“FL”“”FL_number““”-“””rowNumber as a string].value);
  FL_array[“FL”“”FL_number““”-“””rowNumber as a string].XPosition = 59;
  FL_array[“FL”“”FL_number““”-“””rowNumber as a string].YPosition = 18 + rowNumber;
  FL_number = FL_number+1;
  // “NON-COVERED CHARGES”; (i.e., shown in box 48 of the form 140 in FIG. 4)
  FL_array[“FL”“”FL_number““”-“””rowNumber as a string] = a FormLocator;
  FL_array[“FL”“”FL_number““”-“””rowNumber as a string].value =
claim.charges[i].nonCoveredAmount as a string;
  print (“FL”“”FL_number““”-“””rowNumber as a string “ = ”
FL_array[“FL”“”FL_number““”-“””rowNumber as a string].value);
  FL_array[“FL”“”FL_number““”-“””rowNumber as a string].XPosition = 70;
  FL_array[“FL”“”FL_number““”-“””rowNumber as a string].YPosition = 18 + rowNumber;
  FL_number = FL_number+1;
  // “FL49”; (i.e., shown in box 49 of the form 140 in FIG. 4)
  FL_array[“FL”“”FL_number““”-“””rowNumber as a string] = a FormLocator;
  FL_array[“FL”“”FL_number““”-“””rowNumber as a string].value is null;
  print (“FL”“”FL_number““”-“””rowNumber as a string “ = ”
FL_array[“FL”“”FL_number““”-“””rowNumber as a string].value);
  FL_array[“FL”“”FL_number““”-“””rowNumber as a string].XPosition = 81;
  FL_array[“FL”“”FL_number““”-“””rowNumber as a string].YPosition = 18 + rowNumber;
  rowNumber = rowNumber + 1;
  FL_number = boxName.substring(2,4) as an integer;
  i = i + 1;
  }
  FL.formLocatorArray = FL_array as a Hashtable;
  FL.value is null;
  return FL;
}
```

```
if true
then { print(“ End of processing ”);
keys is some Enumeration initially outputForm.buildEnumerationOfKeys( );
nextKey is a string.
print(“\nFormLocators and values from Hashtable are:”).
while (keys.hasMoreElements( ) = true)
  do {
  nextKey = keys.nextElement( ) as a string.
  print(“Form Locator[“ nextKey ”] = ” outputForm[nextKey].value).
  //print(“Form Locator[“ nextKey ”] X position = ” outputForm[nextKey].XPosition).
  //print(“Form Locator[“ nextKey ”] Y position = ” outputForm[nextKey].YPosition).
  if outputForm[nextKey].formLocatorArray <> null
  then {
  tableKeys is some Enumeration initially
  outputForm[nextKey].formLocatorArray as an association from string to
FormLocator.buildEnumerationOfKeys( );
  tableNextKey is a string.
  while (tableKeys.hasMoreElements( ) = true)
  do {
  tableNextKey = tableKeys.nextElement( ) as a string.
  print(“ Form Locator[“ tableNextKey ”] = ” outputForm[nextKey].formLocatorArray
  as an association from string to FormLocator[tableNextKey].value).
  print(“ Form Locator[“ tableNextKey ”] X position = ”
outputForm[nextKey].formLocatorArray
  as an association from string to FormLocator[tableNextKey].XPosition).
  print(“ Form Locator[“ tableNextKey ”] Y position = ”
outputForm[nextKey].formLocatorArray
  as an association from string to FormLocator[tableNextKey].YPosition).
  }
  }
}
```

The following illustrates an example of a printout of output form UB92 hash table for the charge lines portion.

Form Locator[FL42-1] = 002
Form Locator[FL42-1] X position = 4
Form Locator[FL42-1] Y position = 19
Form Locator[FL43-1] = null
Form Locator[FL43-1] X position = 9
Form Locator[FL43-1] Y position = 19
Form Locator[FL44-1] = null
Form Locator[FL44-1] X position = 34
Form Locator[FL44-1] Y position = 19
Form Locator[FL45-1] = null
Form Locator[FL45-1] X position = 44
Form Locator[FL45-1] Y position = 19
Form Locator[FL46-1] = 3.75
Form Locator[FL46-1] X position = 51
Form Locator[FL46-1] Y position = 19
Form Locator[FL47-1] = 432.50
Form Locator[FL47-1] X position = 59
Form Locator[FL47-1] Y position = 19
Form Locator[FL48-1] = null
Form Locator[FL48-1] X position = 70
Form Locator[FL48-1] Y position = 19
Form Locator[FL49-1] = null
Form Locator[FL49-1] X position = 81
Form Locator[FL49-1] Y position = 19
(i.e., the first line of the charge table)
Form Locator[FL42-2] = 010
Form Locator[FL42-2] X position = 4
Form Locator[FL42-2] Y position = 20
Form Locator[FL43-2] = null
Form Locator[FL43-2] X position = 9
Form Locator[FL43-2] Y position = 20
Form Locator[FL44-2] = null
Form Locator[FL44-2] X position = 34
Form Locator[FL44-2] Y position = 20
Form Locator[FL45-2] = null
Form Locator[FL45-2] X position = 44
Form Locator[FL45-2] Y position = 20
Form Locator[FL46-2] = 5
Form Locator[FL46-2] X position = 51
Form Locator[FL46-2] Y position = 20
Form Locator[FL47-2] = 2700
Form Locator[FL47-2] X position = 59
Form Locator[FL47-2] Y position = 20
Form Locator[FL48-2] = null
Form Locator[FL48-2] X position = 70
Form Locator[FL48-2] Y position = 20
Form Locator[FL49-2] = null
Form Locator[FL49-2] X position = 81
Form Locator[FL49-2] Y position = 20
(i.e., the second line of the charge table)
Form Locator[FL42-3] = null
Form Locator[FL42-3] X position = 4
Form Locator[FL42-3] Y position = 21
Form Locator[FL43-3] = null
Form Locator[FL43-3] X position = 9
Form Locator[FL43-3] Y position = 21
Form Locator[FL44-3] = null
Form Locator[FL44-3] X position = 34
Form Locator[FL44-3] Y position = 21
Form Locator[FL45-3] = null
Form Locator[FL45-3] X position = 44
Form Locator[FL45-3] Y position = 2
Form Locator[FL46-3] = null
Form Locator[FL46-3] X position = 51
Form Locator[FL46-3] Y position = 21
Form Locator[FL47-3] = 10.00
Form Locator[FL47-3] X position = 59
Form Locator[FL47-3] Y position = 21
Form Locator[FL48-3] = null
Form Locator[FL48-3] X position = 70
Form Locator[FL48-3] Y position = 21
Form Locator[FL49-3] = null
Form Locator[FL49-3] X position = 81
Form Locator[FL49-3] Y position = 21
(i.e., the third line of the charge table)

The following illustrates an example of XML software that may be generated from the output of the UB92 hash table for the charge lines.

<FormFieldGroup name=“ub92ChargeLine” noOfElements=“23”
startRow=“21”arrangeBy=“row”>
<FormFieldGroup name=“line” arrangeBy=“col”>
<FormField name=“formLocator42” startCol=“4” maxLength=“4” />
<FormField name=“formLocator43” startCol=“9” maxLength=“24” />
<FormField name=“formLocator44” startCol=“34” maxLength=“9” />
<FormField name=“formLocator45” startCol=“44” maxLength=“6” />
<FormField name=“formLocator46” startCol=“51” maxLength=“7” />
<FormField name=“formLocator47” startCol=“59” maxLength=“10” />
<FormField name=“formLocator48” startCol=“70” maxLength=“10” />
<FormField name=“formLocator49” startCol=“81” maxLength=“24” />
</FormFieldGroup>
</FormFieldGroup>

The system 100 advantageously provides data transformable into XML that may be provided to a document for printing. Examples of quick turnaround needed for changing form requirements include the following. In one example, a person makes a change to their “UB92 OP Medicare” form by squeezing in a line of text in the margin of the form. The person makes this form change by changing the rules 144 in the rules engine 134. In another example, the system 100 readily provides paper forms tailored to requirements of a particular state or province in a country by implementing rule changes in the rules engine 134.

The system 100, method 200, and data structures used may be applied in a variety of circumstances, and are not limited to the examples described herein. For example, a user may construct derived data in one system and pass it into another system. The derived data can be anything and would not be pre-defined to the other system. Using the hash table approach, the other system determines the name/value pairs assigned by the user and incorporates the data appropriately into the system.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

1. A system for providing data for incorporation in a form, comprising:
an acquisition processor for automatically acquiring data representing information for incorporation in a form;
a pre-processor for using predetermined rules in processing said acquired data by,
parsing said acquired data to identify individual data elements in said acquired data,
associating said individual data elements with corresponding locations on a target form and
storing said individual data elements and corresponding associated location data in a plurality of data records; and
a transformation processor for converting said plurality of data records into a structured language executable by a processing device.

2. The system according to claim 1, wherein
said corresponding associated location data comprises Cartesian coordinates identifying locations of said individual data elements on a form, and
said plurality of data records comprise a table, incorporating data fields including said individual data elements and associating said individual data elements with corresponding associated coordinates.

3. The system according to claim 1, wherein
said transformation processor converts said plurality of data records into XML compatible data, and
including an XSL processor for processing said XML compatible data to provide said data elements in a form format.

4. The system according to claim 1, wherein
said transformation processor converts said plurality of data records into at least one of the following: (a) XML, (b) SGML, and (c) HTML.

5. The system according to claim 1, including
a repository including a plurality of different sets of predetermined rules adaptively selectable to produce a corresponding plurality of different sets of data records corresponding to a plurality of different forms.

6. The system according to claim 1, wherein
an individual data element is a data object.

7. The system according to claim 1, wherein
said pre-processor includes a rules engine for applying said predetermined rules.

8. The system according to claim 1, wherein
said plurality of data records includes an individual data element and corresponding associated location data and said individual data element comprises a second plurality of individual data elements and corresponding associated location data.

9. The system according to claim 8, wherein
said second plurality of individual data elements and corresponding associated location data comprises a plurality of data records comprising a table.

10. A method for providing data for incorporation in a form, comprising the steps of:
acquiring data representing information for incorporation in a form;
using predetermined rules in processing said acquired data by:
parsing said acquired data to identify individual data elements in said acquired data,
associating said individual data elements with corresponding locations on a target form and
storing said individual data elements and corresponding associated location data in a plurality of data records; and
converting said plurality of data records into a structured language executable by a processing device.

11. The method according to claim 10, wherein
said corresponding associated location data comprises Cartesian coordinates identifying locations of said individual data elements on a form, and
said plurality of data records comprise a table, incorporating data fields including said individual data elements and associating said individual data elements with corresponding associated coordinates.

12. The method according to claim 10, wherein
said structured language further comprises XML compatible data, and
wherein the method further comprises the step of:
processing said XML compatible data to provide said data elements in a form format.

13. The method according to claim 10, wherein
said structured language further comprises at least one of the following: (a) XML, (b) SGML, and (c) HTML.

14. The method according to claim 10, further comprising the step of:
storing a plurality of different sets of predetermined rules adaptively selectable to produce a corresponding plurality of different sets of data records corresponding to a plurality of different forms.

15. The method according to claim 10, wherein
an individual data element is a data object.

16. The method according to claim 10, wherein
said plurality of data records includes an individual data element and corresponding associated location data and said individual data element comprises a second plurality of individual data elements and corresponding associated location data.

17. The method according to claim 10, wherein
said second plurality of individual data elements and corresponding associated location data comprises a plurality of data records comprising a table.

18. A user interface comprising:
a data input device coupled to a processor that performs the following steps:
acquiring data representing information for incorporation in a form;
using predetermined rules in processing said acquired data by:
parsing said acquired data to identify individual data elements in said acquired data,
associating said individual data elements with corresponding locations on a target form and
storing said individual data elements and corresponding associated location data in a plurality of data records; and
converting said plurality of data records into a structured language executable by a processing device
a data output device for permitting the user to receive feedback about one or more of the steps performed by the processor.

19. A user interface according to claim 18, wherein the data input device and the data output device permits the user to modify, add to, or modify and add to the predetermined rules.

20. A user interface according to claim 18, wherein the data input device and the data output device permits the user to select a set of the predetermined rules from a plurality of sets of the predetermined rules.
